(19) United States
(12) Patent Application Publication
(10) Pub. No.: US 2020/0412204 A1
(43) Pub. Date: Dec. 31, 2020

(54) ROTOR BLADE APPARATUS

(71) Applicant: NIDEC CORPORATION, Kyoto (JP)

(72) Inventors: Daisuke OGASAWARA, Kyoto (JP); Satoshi KAJIKAWA, Kyoto (JP); Yusuke MAKINO, Kyoto (JP)

(21) Appl. No.: 16/979,171

(22) PCT Filed: Mar. 27, 2019
(86) PCT No.: PCT/JP2019/013321

§ 371 Date: Sep. 9, 2020

(30) Foreign Application Priority Data
Mar. 28, 2018 (JP) 2018-061194

(51) Int. Cl. H02K 9/06; H02K 5/18; H02K 5/20

(52) U.S. Cl. CPC H02K 9/06; H02K 5/20; H02K 5/18

(57) ABSTRACT

A rotor blade apparatus includes a motor and a propeller. The motor includes a motor body having a rotor that rotates about a central axis, and an output part that is connected to the rotor and protrudes from the motor body to one side in an axial direction. The propeller is fixed to one axial end of the output part. The propeller has a flat portion that spreads in a direction orthogonal to the axial direction at a radially inner portion that faces a surface of the motor body facing one side in the axial direction. The rotor blade apparatus includes a fan that is provided between the flat portion and the motor body and is fixed to the output part. At least one blade of the fan faces the propeller in the axial direction with a gap.

### CROSS-REFERENCE TO RELATED APPLICATIONS

This is the U.S. national stage of application No. PCT/JP2019/013321, filed on Mar. 27, 2019, and priority under 35 U.S.C. § 119(a) and 35 U.S.C. § 365(b) is claimed from Japanese Application No. 2018-061194, filed on Mar. 28, 2018.

### FIELD OF THE INVENTION

The present invention relates to a rotor blade apparatus.

### BACKGROUND

Conventionally, in an apparatus including a propeller and a motor that drives the propeller, a structure of cooling a motor that is a heat source is known. For example, there is known an outer rotor type motor configured to allow the air to flow from the opening to the inside.

In a rotor blade apparatus, the vicinity of the central axis of a propeller is a flat surface that is not twisted and does not generate wind in order to avoid interference with the motor. Therefore, the wind generated by the propeller hardly hits the motor and contributes little to the cooling of the motor.

### SUMMARY

According to an exemplary embodiment of the present invention, a rotor blade apparatus including a motor and a propeller is provided. The motor includes a motor body having a rotor that rotates about a central axis, and an output part that is connected to the rotor and protrudes from the motor body to one side in an axial direction. The propeller is fixed to one axial end of the output part. The propeller has a flat portion that spreads in a direction orthogonal to the axial direction at a radially inner portion that faces a surface of the motor body facing one side in the axial direction. The rotor blade apparatus includes a fan that is provided between the flat portion and the motor body and is fixed to the output part. At least one blade of the fan faces the propeller in the axial direction with a gap.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view showing a rotor blade apparatus of an embodiment;

FIG. 2 is a cross-sectional view of the rotor blade apparatus of the embodiment;

FIG. 3 is a diagram showing air flow distribution during operation of the rotor blade apparatus of the embodiment;

FIG. 4 is a diagram showing airflow distribution during operation of a configuration in which a fan is omitted in a rotor blade apparatus for comparison;

FIG. 5 is a diagram showing a rotor blade apparatus of a modified example; and

FIG. 6 is a diagram showing air flow distribution during operation of the rotor blade apparatus of the modified example.

### DETAILED DESCRIPTION

Hereinafter, an embodiment of the invention will be described with reference to the drawings.

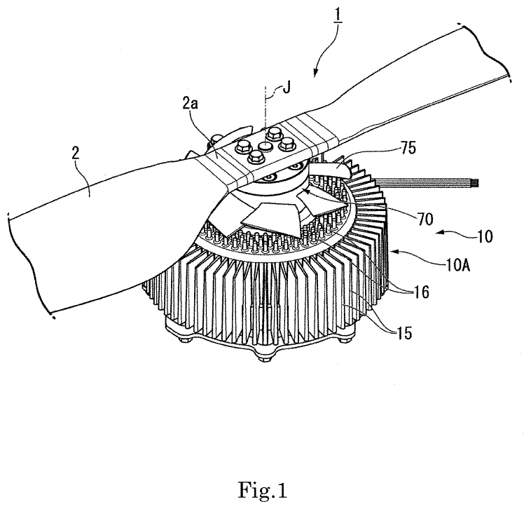

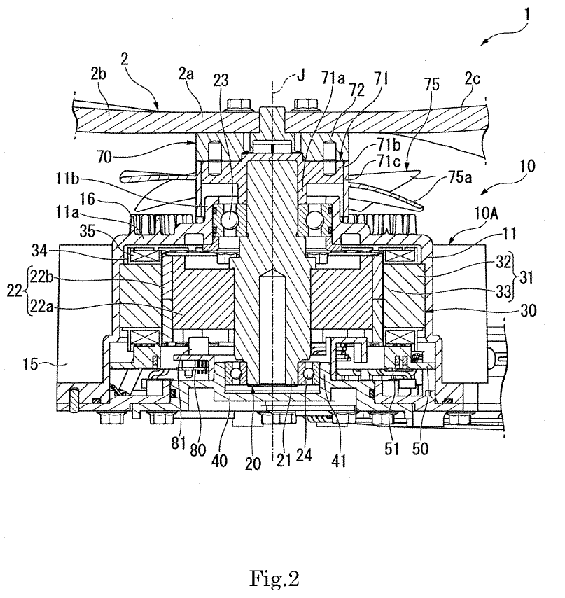

FIG. 1 is a perspective view showing a rotor blade apparatus of the present embodiment. FIG. 2 is a cross-sectional view of the rotor blade apparatus of the present embodiment.

In the following description, a direction in which the central axis J shown in FIGS. 1 and 2 extends is a vertical direction. One side in the axial direction of the central axis J is simply referred to as an “upper side”, and the other side in the axial direction is simply referred to as a “lower side”. It should be noted that the vertical direction is an expression used made simply for the sake of description, and is not meant to restrict actual relative position and direction. Furthermore, a direction parallel to the central axis J is simply referred to as an “axial direction”, a radial direction having the central axis J as the center is simply referred to as a “radial direction”, and a circumferential direction about the central axis J is simply referred to as a “circumferential direction”.

In the present specification, the expression of “extending in the axial direction” includes not only the case of strictly extending in the axial direction, but also the case of extending in a direction inclined in a range of less than 45° with respect to the axial direction. In addition, in the present specification, the expression of “extending in the radial direction” includes not only the case of strictly extending in the radial direction, that is, in a direction perpendicular to the axial direction, but also the case of extending in a direction inclined in a range of less than 45° with respect to the radial direction.

As shown in FIG. 1, the rotor blade apparatus 1 includes a motor 10, a propeller 2, and a fan 75. The motor 10 has a motor body 10A and an output part 70 connected to the shaft 21 of the motor body 10A. The propeller 2 is fixed to the upper end of the output part 70. The fan 75 is fixed to the side surface of the output part 70. As shown in FIG. 2, the motor body 10A includes a housing 11, a bearing holder 40, bearings 23 and 24, a rotor 20, and a stator 30.

The housing 11 has a top wall portion 11a and has a cylindrical shape that opens downward. The top wall portion 11a axially faces the propeller 2. The housing 11 has a tubular portion 11b that holds the bearing 23 in the central portion of the top wall portion 11a when viewed in the axial direction. The bearing 23 is disposed inside the tubular portion 11b. The tubular portion 11b protrudes upward from the top wall portion 11a of the housing 11.

The housing 11 has a plurality of plate-shaped side fins 15 extending radially outward from the side surface. Each side fin 15 extends vertically from the upper end to the lower end of the side surface of the housing 11. The top wall portion 11a has a plurality of pillar-shaped top fins 16 protruding upward from the upper surface of the top wall portion 11a. The top fins 16 are arranged in an annular region surrounding the tubular portion 11b in the circumferential direction.

The bearing holder 40 is fixed to the lower opening of the housing 11. The bearing holder 40 has a cylindrical holder tubular portion 41 that opens upward. The bearing holder 40 holds the bearing 24 in the holder tubular portion 41. The rotor 20, the stator 30, the bus bar holder 50, and a circuit board 80 are housed in the internal space surrounded by the housing 11 and the bearing holder 40.

The rotor 20 includes a shaft 21 and a rotor body 22. The shaft 21 is disposed along the central axis J. The shaft 21 has a columnar shape centered on the central axis J. The shaft 21 is supported by the bearings 23 and 24 so as to be rotatable about the central axis J. The upper end of the shaft 21 protrudes outside the housing 11 through a hole provided in the top wall portion 11a of the housing 11. The rotor body 22 has a rotor core 22a fixed to the outer peripheral surface of the shaft 21, and a rotor magnet 22b fixed to the outer peripheral surface of the rotor core 22a.

The stator 30 faces the rotor 20 in the axial direction with a gap. The stator 30 has a stator core 31, an insulator 34, and a plurality of coils 35. The stator core 31 has an annular shape that surrounds the rotor body 22 on the radially outer side of the rotor body 22. The stator core 31 includes a core back 32 and a plurality of teeth 33. The core back 32 has an annular shape centered on the central axis J. The teeth 33 protrude radially inward from the core back 32. The teeth 33 are arranged at regular intervals along one round in the circumferential direction.

The insulator 34 is a member that insulates the coil 35 and the stator core 31 from each other. The insulator 34 is attached to each of the plurality of teeth 33. The plurality of coils 35 are attached to each of the plurality of teeth 33 via the insulator 34. In the case of the present embodiment, the coil 35 is resin-molded together with the stator core 31 and the insulator 34. The upper end surface of the mold resin contacts the lower surface of the top wall portion 11a. That is, the coil 35 and the top wall portion 11a are thermally connected by the mold resin. Part of the heat generated in the coil 35 is transmitted to the top fins 16 via the resin mold and the top wall portion 11a, and is radiated from the top fins 16.

The bus bar holder 50 is arranged below the stator 30. The bus bar holder 50 holds a plurality of busbars 51. The busbars 51 are connected to lead wires extending from the coils 35. The circuit board 80 has a plate shape that expands in the radial direction. The circuit board 80 is disposed below the stator 30. In the present embodiment, the circuit board 80 is disposed radially outside the holder tubular portion 41. The circuit board 80 has a plurality of Hall sensors 81. The Hall sensor 81 detects the magnetic field of the rotor magnet 22b.

The output part 70 is fixed to the tip of the shaft 21 protruding upward from the housing 11. The output part 70 includes an attachment member 71 connected to the shaft 21 and a connecting member 72 fixed to the upper side of the attachment member 71.

The attachment member 71 includes a cylindrical shaft portion 71a that extends axially along the shaft 21, a flange portion 71b that extends radially from the outer peripheral surface of the shaft portion 71a, and a tubular portion 71c having a cylindrical shape and fixed to a radially outer end of the flange portion 71b. The fan 75 is fixed to the tubular portion 71c. The fan 75 has a plurality of blades 75a extending radially outward from the outer peripheral surface of the tubular portion 71c. In the present embodiment, the fan 75 is an axial fan that blows air in the axial direction.

In the present embodiment, the attachment member 71 and the fan 75 are manufactured by insert molding. The shaft portion 71a and the flange portion 71b are a single member made of metal. The tubular portion 71c and the fan 75 are parts of a single resin member.

The outer diameter of the fan 75 is smaller than the outer diameter of the propeller 2. With this configuration, the interference between the propeller 2 and the fan 75 can be suppressed. Moreover, it is possible to suppress an increase in the weight of the rotor blade apparatus 1.

The connecting member 72 is fixed to the upper surface of the attachment member 71. The connecting member 72 is a disk-shaped member, and is bolted to the attachment member 71. The propeller 2 is fixed to the upper surface of the connecting member 72.

The propeller 2 has a hub 2a located in the central portion when viewed in the axial direction, and two blades 2b and 2c extending radially outward from the hub 2a. The hub 2a has a flat plate shape whose upper and lower surfaces are flat. That is, the propeller 2 has a flat portion 2d that spreads in a direction orthogonal to the axial direction at the radially inner portion facing the upper surface of the motor body 10A. In the present embodiment, the flat portion 2d refers to a portion of the propeller 2 that does not substantially generate an air flow in the axial direction, and is a portion that is not substantially inclined with respect to the rotation direction of the propeller 2. The hub 2a has a through hole penetrating in the axial direction. The propeller 2 is fixed to the connecting member 72 by a bolt that penetrates the through hole of the hub 2a.

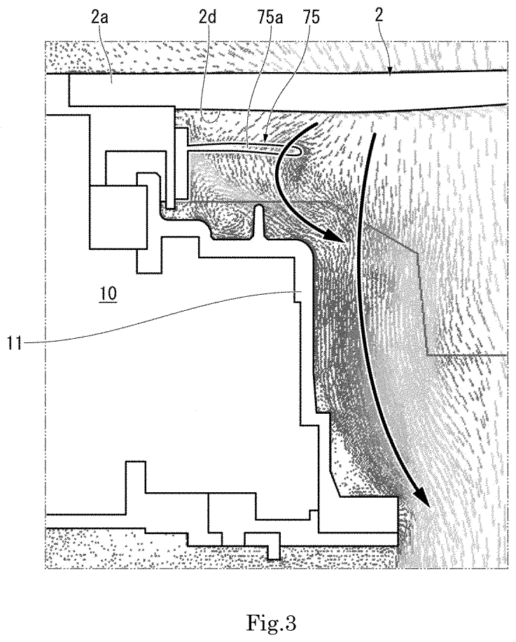

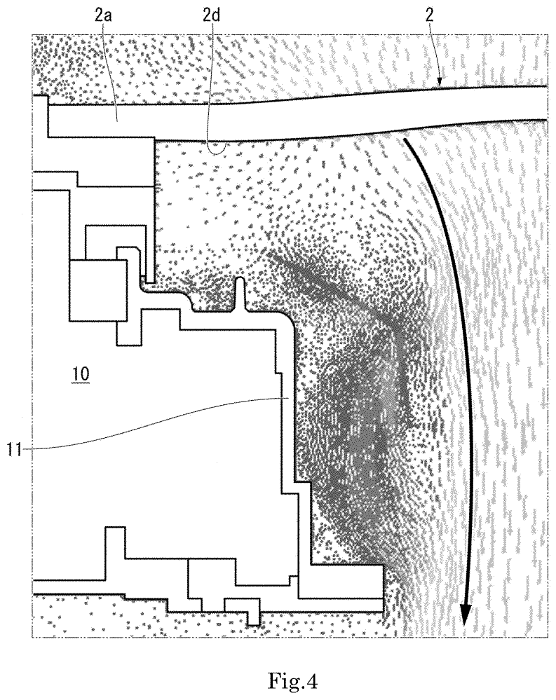

In the present embodiment, at least one blade 75a of the fan 75 faces the flat portion 2d of the propeller 2 in the axial direction with a gap. With this configuration, the cooling efficiency of the motor 10 can be improved. Here, FIG. 3 is a diagram showing airflow distribution during operation of the rotor blade apparatus 1 of the present embodiment. For comparison, FIG. 4 is a diagram showing airflow distribution during operation of the configuration in which the fan 75 is omitted in the rotor blade apparatus 1.

First, as shown in FIG. 4, when the fan 75 is not provided between the propeller 2 and the motor 10, most of the airflow generated by the propeller 2 passes through a position away from the motor 10. In the vicinity of the housing 11, a weak airflow is generated on the side surface of the housing 11, but almost no airflow is generated on the upper surface of the housing 11. This is because the hub 2a of the propeller 2 located on the upper side of the housing 11 has a flat plate shape, and even if the propeller 2 rotates, a downward airflow is not generated in the hub 2a portion.

On the other hand, in the rotor blade apparatus 1 including the fan 75, as shown in FIG. 3, a downward airflow is generated around the fan 75, and the wind hits the upper surface of the housing 11. Furthermore, as compared with the configuration of FIG. 4, the airflow generated by the propeller 2 passes through a position near the housing 11. As a result, the flow velocity increases on the side surface of the housing 11, so that the motor 10 can be cooled efficiently.

The reason why the airflow of the propeller 2 passes near the housing 11 as described above is that the blades 75a of the fan 75 are arranged at a position facing the flat portion 2d of the propeller 2 in the axial direction with a gap. According to this configuration, when the fan 75 rotates to generate a downward airflow, the pressure in the space between the blade 75a and the flat portion 2d decreases. Due to the negative pressure generated between the blade 75a and the flat portion 2d, the air on the lower surface side of the blades 2b and 2c of the propeller 2 is drawn to the central axis J side. As a result, the airflow generated by the propeller 2 is drawn toward the housing 11 side, and the flow velocity of the airflow increases on the side surface of the housing 11.

In the rotor blade apparatus 1 of the present embodiment, the fan 75 is disposed below the propeller 2 to thereby change the flow of wind around the housing 11 to facilitate cooling of the motor 10. Therefore, a member for guiding the wind to the housing 11 is not necessary, and the cooling efficiency can be improved without complicating the structure.

The motor 10 of the present embodiment is an inner rotor type motor having a stator 30 located radially outside the rotor 20. Generally, in an inner rotor type motor, since it is difficult for the air to circulate inside a housing that houses the stator, the stator is less likely to be cooled than in an outer rotor type motor. On the other hand, in the present embodiment, the airflow of the propeller 2 can be drawn to the side surface of the housing 11 near the stator 30, which is a heat source, to increase the flow velocity. Therefore, high cooling efficiency can be obtained even in the inner rotor type motor 10.

Further, in the motor 10 of this embodiment, the rotor 20 and the stator 30 are covered by the housing 11. This makes it easier to cool the motor 10 by the airflow from the propeller 2 while improving the waterproofness and dustproofness of the motor 10.

In addition, in the present embodiment, since the side fins 15 are provided on the side surface of the housing 11, the airflow of the propeller 2 drawn toward the housing 11 side by the action of the fan 75 hits the side fins 15. Further, since the top fins 16 are provided on the upper surface of the housing 11, the air flow generated by the fan 75 hits the top fins 16. By these, higher cooling efficiency can be obtained.

In the present embodiment, the outer diameter of the fan 75 is larger than the outer diameter of the flat portion 2d of the propeller 2. As a result, the airflow of the propeller 2 and the airflow of the fan 75 are combined, and the flow velocity can be increased over a wide range of the upper surface and the side surface of the housing 11.

If the axial distance between the fan 75 and the propeller 2 is short, the blades 75a of the fan 75 and the blades 2b and 2c of the propeller 2 are likely to interfere with each other. Therefore, the outer diameter of the fan 75 may be smaller than the outer diameter of the flat portion 2d. According to the present embodiment, even if the fan 75 is made small, deterioration of the cooling efficiency is suppressed by the action of drawing the airflow of the propeller 2 toward the central axis J. Since the outer diameter of the fan 75 is smaller than the outer diameter of the flat portion 2d of the propeller 2, it is possible to prevent interference between the propeller 2 and the fan 75.

In the present embodiment, the outer diameter of the flat portion 2d of the propeller 2 is smaller than the outer diameter of the motor body 10A. Further, the outer diameter of the flat portion 2d is smaller than the outer diameter of the tubular portion of the housing 11 excluding the side fins 15. As a result, when viewed in the axial direction, the area where the motor body 10A and the blades 2b and 2c of the propeller 2 overlap becomes large. Therefore, the airflow of the propeller 2 easily hits the motor body 10A, and high cooling efficiency is easily obtained.

On the other hand, in the rotor blade apparatus 1 including a small motor 10, the outer diameter of the flat portion 2d of the propeller 2 may be larger than the outer diameter of the motor body 10A. Even in this case, in the present embodiment, the airflow of the propeller 2 is drawn toward the central axis J side by the action of the fan 75, so that the airflow of the propeller 2 easily hits the motor 10 and a relatively high cooling effect is obtained. Further, since the outer diameter of the flat portion 2d of the propeller 2 is larger than the outer diameter of the motor body 10A, it is possible to prevent interference between the propeller 2 and the motor body 10A.

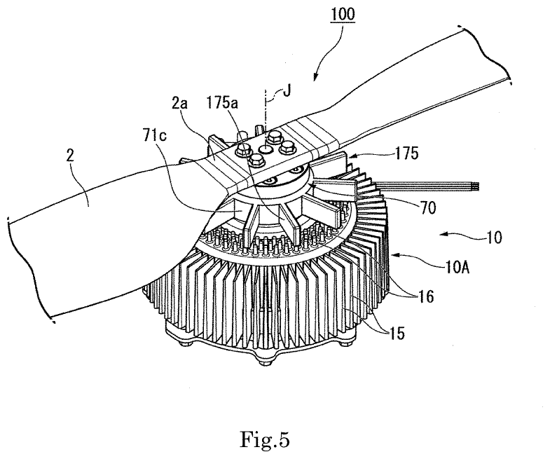

FIG. 5 is a diagram showing a rotor blade apparatus 100 of a modified example.

The present modified example has a configuration in which a centrifugal fan is provided instead of the axial fan of the above embodiment. The configuration other than the form of the fan is common to the rotor blade apparatus 1 of the above-described embodiment.

The rotor blade apparatus 100 includes a motor 10, a propeller 2, and a fan 175. The fan 175 is fixed to the output part 70 of the motor 10. The fan 175 has a plurality of blades 175a extending radially to the outside in the radial direction from the tubular portion 71c of the output part 70. The blade 175a has a flat plate shape extending in the radial direction. The plate surface of the blade 175a is parallel to the axial direction. As a result, the motor 10 can be efficiently cooled regardless of the rotation direction of the fan 175.

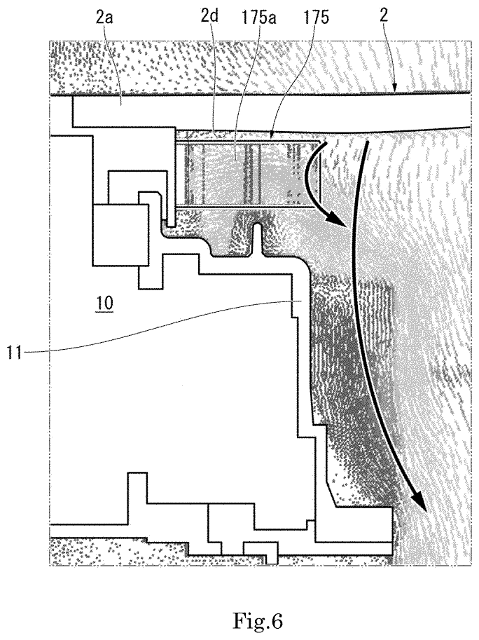

Even in a configuration in which a centrifugal fan is provided between the propeller 2 and the motor body 10A, the same operational effects as those of the above embodiment can be obtained. FIG. 6 is a diagram showing airflow distribution during operation in the modified rotor blade apparatus 100.

As shown in FIG. 6, since the fan 175 is a centrifugal fan, when the rotor blade apparatus 100 is operated, the airflow generated by the fan 175 is directed radially outward. Then, the wind flowing outward from the fan 175 merges with the airflow of the propeller 2 and flows downward along the side surface of the housing 11. As a result, compared with the configuration shown in FIG. 4, the airflow generated by the propeller 2 passes through a position closer to the housing 11. As a result, the flow velocity increases on the side surface of the housing 11, so that the motor 10 can be cooled efficiently.

Even in the modified example, the blades 175a of the fan 175 face the flat portion 2d of the propeller 2 in the axial direction with a gap. The fan 175 does not generate an airflow in the axial direction, but generates an airflow directed radially outward between the housing 11 and the flat portion 2d. This reduces the pressure at the top and bottom of the fan 175. Due to the negative pressure between the blades 175a and the flat portion 2d, the air on the lower surface side of the blades 2b and 2c of the propeller 2 is drawn toward the central axis J side. As a result, the airflow generated by the propeller 2 is drawn toward the housing 11 side.

In the rotor blade apparatus 100 of the present embodiment, the heat of the top fins 16 is radiated outward in the radial direction by the radial airflow generated by the fan 175. Further, the action of the fan 175 increases the flow velocity in the vicinity of the side surface of the housing 11, so that the heat dissipation from the side fins 15 is also improved.

Even in the modified example, the outer diameter of the fan 175 is larger than the outer diameter of the flat portion 2d of the propeller 2, but when the axial distance between the fan 175 and the propeller 2 is short, the outer diameter of the fan 175 may be smaller than the outer diameter of the flat portion 2d.

In the above embodiment, the rotor blade apparatus 1 including the inner rotor type motor 10 has been described, but the above-described configuration may be adopted for an outer rotor type motor and applied to a rotor blade apparatus.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A rotor blade apparatus comprising:
a motor including a motor body having a rotor that rotates about a central axis, and an output part that is connected to the rotor and protrudes from the motor body to one side in an axial direction; and
a propeller fixed to one axial end of the output part,
wherein
the propeller has a flat portion that spreads in a direction orthogonal to the axial direction at a radially inner portion that faces a surface of the motor body facing one side in the axial direction,
the rotor blade apparatus comprises a fan that is provided between the flat portion and the motor body and is fixed to the output part, and
at least one blade of the fan faces the propeller in the axial direction with a gap.

2. The rotor blade apparatus according to claim 1, wherein the motor body has a stator located radially outside the rotor.

3. The rotor blade apparatus according to claim 2, wherein the motor body has a housing that covers at least a part of an outer peripheral surface of the stator.

4. The rotor blade apparatus according to claim 3, wherein the housing has a plurality of side fins protruding radially outward from an outer peripheral surface.

5. The rotor blade apparatus according to claim 3, wherein
the housing has a top wall portion that axially faces the propeller, and
the top wall portion has a plurality of top fins that protrude from a surface facing the propeller to one side in the axial direction.

6. The rotor blade apparatus according to claim 1, wherein an outer diameter of the fan is smaller than an outer diameter of the propeller.

7. The rotor blade apparatus according to claim 1, wherein an outer diameter of the fan is larger than an outer diameter of the flat portion.

8. The rotor blade apparatus according to claim 1, wherein an outer diameter of the fan is smaller than an outer diameter of the flat portion.

9. The rotor blade apparatus according to claim 1, wherein an outer diameter of the flat portion is smaller than an outer diameter of the motor body.

10. The rotor blade apparatus according to claim 1, wherein an outer diameter of the flat portion is larger than an outer diameter of the motor body.

11. The rotor blade apparatus according to claim 1, wherein the fan is an axial fan.

12. The rotor blade apparatus according to claim 1, wherein the fan is a centrifugal fan.
